(19) United States
(12) Patent Application Publication
(10) Pub. No.: US 2018/0089212 A1
(43) Pub. Date: Mar. 29, 2018

(54) DYNAMIC SUGGESTIONS FOR ITERATIVE SEARCH

(71) Applicant: Twiggle Ltd., Tel-Aviv (IL)

(72) Inventors: Arbel DEUTSCH PELED, Tel-Aviv (IL); Avishay LAVIE, Tel-Aviv (IL); Deborah Alexandra LALOUM, Tel-Aviv (IL); Tomer ARAZY, Tel-Aviv (IL)

(21) Appl. No.: 15/681,514

(22) Filed: Aug. 21, 2017

Related U.S. Application Data
(63) Continuation-in-part of application No. 15/416,337, filed on Jan. 26, 2017.
Application No. 15/416,337 is a continuation-in-part of application No. 15/275,620, filed on Sep. 26, 2016.

(51) Int. Cl. G06F 17/30

(52) U.S. Cl. CPC G06F 17/3097; G06F 17/30442; G06F 17/30646; G06F 17/30867

(57) ABSTRACT

A computer-implemented method performed at a server system for enhancing search queries received from client devices. The method comprises maintaining a dataset mapping a co-appearance prevalence of at least two attribute values of each of a plurality of attributes of each of a plurality of product categories in a plurality search queries submitted to a search engine and during a single search thread, receiving at the server system a plurality of evolving search phrases from a search requestor at a client device that is distinct from the server system.

### RELATED APPLICATIONS

This application is a Continuation-In-Part (CIP) of U.S. patent application Ser. No. 15/416,337, filed on Jan. 26, 2017, which is a Continuation-In-Part (CIP) of U.S. patent application Ser. No. 15/275,620, filed on Sep. 26, 2016. The contents of the above applications are all incorporated by reference as if fully set forth herein in their entirety.

### FIELD AND BACKGROUND OF THE INVENTION

The present invention, in some embodiments thereof, relates to web searches and, more specifically, but not exclusively, to product-related searches in e-commerce websites or applications of devices such as mobile device and/or voice controlled device, and/or any presentation devices.

Known e-commerce product search services utilize keyword search engines. Such engines intrinsically or by design do not take into account relations between e-commerce concepts.

### SUMMARY OF THE INVENTION

According to some embodiments of the present invention, there is provided a computer-implemented method performed at a server system for enhancing search queries received from client devices. The method comprises maintaining a dataset mapping a co-appearance prevalence of at least two attribute values of each of a plurality of attributes of each of a plurality of product categories in a plurality search queries submitted to a search engine, during a single search thread, receiving at the server system a plurality of evolving search phrases from a search requestor at a client device that is distinct from the server system, at the server system, responding to each of the plurality of evolving search phrases by: performing a content analysis of the respective evolving search phrase to identify a group of attribute values of values from the plurality of attributes of one of the plurality of product categories, identifying a plurality of complementary phrase terms to the respective evolving search phrase according to respective the co-appearance prevalence related to members of the group of attribute values, and instructing a presentation of a response to the respective evolving search phrase with the plurality of complementary phrase terms in association with a plurality of interactive elements. A selection of one of the plurality of interactive elements triggers a submission of a following evolving search phrase from the search requestor at the client device, the following evolving search phrase combines the selected complementary phrase term with at least some members from the group.

Optionally, the responding comprises submitting the respective evolving search phrase to a search engine and acquiring the response from the search engine.

Optionally, the at least two attribute values and the plurality of attributes of each of the plurality of product categories are mapped in a hierarchic object model mapping hierarchic relations between the plurality of attributes; wherein the identifying is performed using the model.

Optionally, the content analysis comprises a natural language analysis of the respective evolving search phrase.

Optionally, the group of attribute values are parsed using the hierarchic model.

Optionally, the evolving search phrase is an input text provided by a user during a conversational search.

Optionally, the method further comprises at the server system, responding to at least one additional evolving search phrase by: identifying a new attribute value in the at least one additional evolving search phrase. When the new attribute value is of an existing attribute value of a similar attribute in the following evolving search phrase, replacing the existing attribute value with the new attribute value and submitting an adapted version of the following evolving search phrase as an additional evolving search phrase from the search requestor at the client device. When the new attribute value is of an attribute having no value in the following evolving search phrase, adding the new attribute value to the following evolving search phrase and submitting the enhanced version of the following evolving search phrase as an additional evolving search phrase from the search requestor at the client device.

Optionally, the method further comprises at the server system, responding to at least one additional evolving search phrase by: identifying a product category in the at least one additional evolving search phrase. When the product category is different from a product category identified in the following evolving search phrase, starting a new search thread.

According to some embodiments of the present invention, there is provided a server system for enhancing search queries received from client devices. The system comprises a memory adapted to store a dataset mapping a co-appearance prevalence of at least two attribute values of each of a plurality of attributes of each of a plurality of product categories in a plurality search queries submitted to a search engine, at least one processor adapted to: receive, during a single search thread, a plurality of evolving search phrases from a search requestor at a client device that is distinct from the server system, respond to each of the plurality of evolving search phrases by: performing a content analysis of the respective evolving search phrase to identify a group of attribute values of values from the plurality of attributes of one of the plurality of product categories, identifying a plurality of complementary phrase terms to the respective evolving search phrase according to respective the co-appearance prevalence related to members of the group of attribute values, and instruct a presentation of a response to the respective evolving search phrase with the plurality of complementary phrase terms in association with a plurality of interactive elements. A selection of one of the plurality of interactive elements triggers a submission of a following evolving search phrase from the search requestor at the client device, the following evolving search phrase combines the selected complementary phrase term with at least some members from the group.

According to some embodiments of the present invention, there is provided a computer-implemented method for processing a conversational search thread, comprising: sequentially adding to an iterative search, at the server system, a plurality of phrase terms from a search requestor at a client system distinct from the server system, in response to each sequential addition of the plurality of phrase terms updating a presentation of a response to a current state of the iterative search, in each the sequential addition: when a first attribute value of a specific attribute identified in one of the plurality of phrase terms is different from a second attribute value of the specific attribute in a preceding phrase term, replacing the first attribute value with the second attribute value in the current state of the iterative search, when a third attribute value of an attribute not currently found in the current state of the iterative search is identified in one of the plurality of phrase terms adding the third attribute value to the current state of the iterative search and when a product category in a third phrase term of the plurality of phrase terms is different from a product category identified in a preceding phrase term, deleting all attribute values in the current state of the iterative search.

Optionally, in each of a plurality of iterations of the sequential addition the response is acquired form a search engine by submitting one of the second attribute value, the third attribute value, and the third phrase term to the search engine.

Optionally, in each of a plurality of iterations of the sequential addition a natural language analysis is used to deduce the plurality of phrase terms.

Optionally, the plurality of phrase terms are provided by a user during a conversational search.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a computer-implemented method performed at a server system for dynamically and iteratively providing complementary phrase terms to evolving search phrases, according to some embodiments of the present invention;

FIG. 2 is a schematic illustration of a server system facilitating the implementation of the method depicted in FIG. 1, according to some embodiments of the present invention;

FIG. 3A is an exemplary flow depicting how raw queries are translated into output suggestion of complementary phrase terms sorted according to attribute types, according to some embodiments of the present invention;

FIG. 3B depicts presentation of facets as buttons in proximity to a search field, according to some embodiments of the present invention;

FIGS. 3C-3D depict presentation of multiple facets of the same attribute type when clustered to be selected in common GUI element, according to some embodiments of the present invention;

FIGS. 4A-4D are screenshots of attribute values presented as complementary phrase terms which are dynamically calculated according to a current state of a search phrase, according to some embodiments of the present invention; and

FIG. 5 is a flowchart for managing a conversational search thread, according to some embodiments of the present application.

### DESCRIPTION OF SPECIFIC EMBODIMENTS OF THE INVENTION

The present invention, in some embodiments thereof, relates to web searches and, more specifically, but not exclusively, to product-related searches in e-commerce websites or applications of devices such as mobile device and/or voice controlled device, and/or any presentation devices.

According to some embodiments of the present invention, there is provided methods and systems of dynamically calculating complementary phrase terms to a search phrase based on the analysis of co appearance of attribute values of attributes of products or services in historical search queries, optionally using a ontology defined in a model, for example a model as described in as described in U.S. patent application Ser. No. 15/416,337 Filed on 26 Jan. 2017 and/or in U.S. patent application Ser. No. 15/275,620 filed on 26 Sep. 2016 which are incorporated herein by reference.

The claimed invention enables automatic, context based, selection of the attribute values and not only attribute values based on statistical information. The ontology allows identifying to which product the values defined in the historical search queries are related and to which attributes values defined in the historical search queries are related. Different historical search queries may be clustered accordingly. The complementary phrase terms are optionally converted into selectable graphical elements, allowing a user to select them by a single click or touch, creating by this selection a new search phrase that combines phrase terms from the search phrase with the selected complementary phrase term. The methods and systems improves the accuracy, speed and usability of the complementary phrase terms and allows avoiding calculation of illogical or contradictory complementary phrase terms by selecting complementary phrase term based on analysis of actual search queries.

According to some embodiments of the present invention, there is provided methods and systems of dynamically adapting a search of a conversational search thread by matching certain attribute values found in a certain search phrase of the conversational search thread with following attribute values which are found in a following search phrase of the conversational search thread. The match allows identifying whether the following attribute values are substitutional phrase terms or complementary phrase terms to the certain search phrase. When the attribute values are substitutional phrase terms, some or all of the certain attribute values may be replaced with some or all of the following attribute values to form an updated search. When the attribute values are complementary phrase terms, some or all of the complementary phrase terms are added to the certain attribute values to form the updated search.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

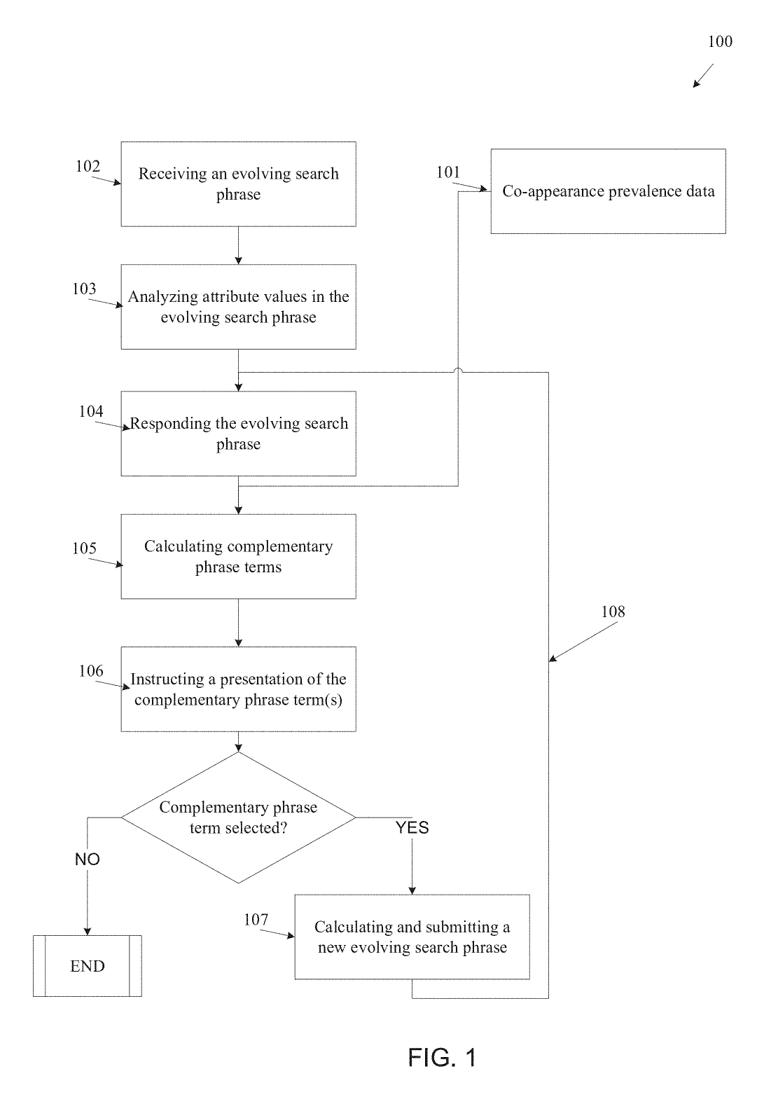

Reference is now made to FIG. 1, which is a flowchart of a computer-implemented method performed at a server system for dynamically and optionally iteratively providing complementary phrase terms to evolving search phrases based on an analysis of co-appearance of phrase terms in historical search queries and the classification of values of phrase terms used therein, according to some embodiments of the present invention. The complementary phrase terms are provided during a single search thread such as a session of an iterative search during which multiple queries are submitted to a search engine and responded by the search engine. A single search thread is an interactive user(s)-machine session during which a one or more user(s) searches for search complying products or services by inputting phrase terms in a plurality of separate search interactions. In each search interaction search complying products or services are presented to the user and in each search interaction the used evolving search phrases are different from one another by one or more phrase terms. The process is optionally implemented during a conversational search thread, namely as part of a chat like interaction between the user and a search service. In such a thread inputs given in one interaction (e.g. phrase terms inputted or otherwise provided by a user and used for generating search results) are taken into account in a following interaction for instance for generating new search results.

In each interaction content analysis processes may be used for extracting and optionally canonizing phrase terms, for instance using an NLP engine.

By recommending phrase terms to users based on complementary phrase terms, suggestions of illogical or contradictory phrase terms are avoided as the prevalence of illogical or contradictory co-appearance of phrase terms in historical search queries is negligible.

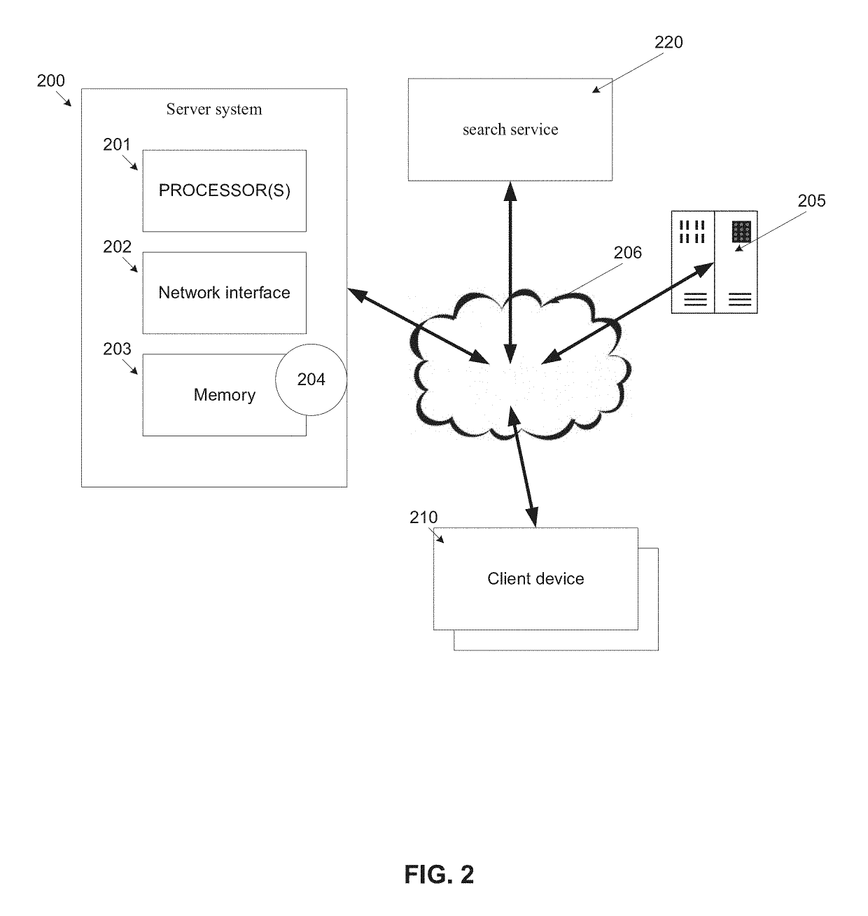

FIG. 2 is a schematic illustration of a server system 200 facilitating an implementation of the method depicted in FIG. 1, according to some embodiments of the present invention.

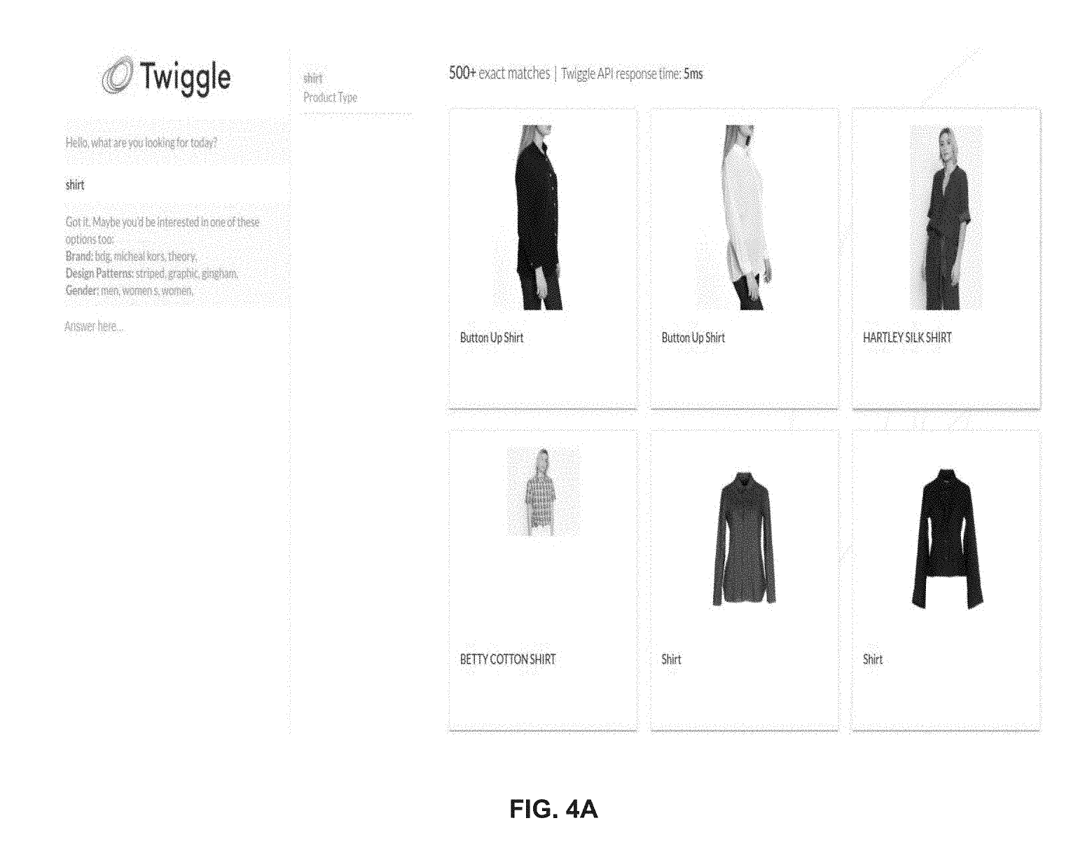

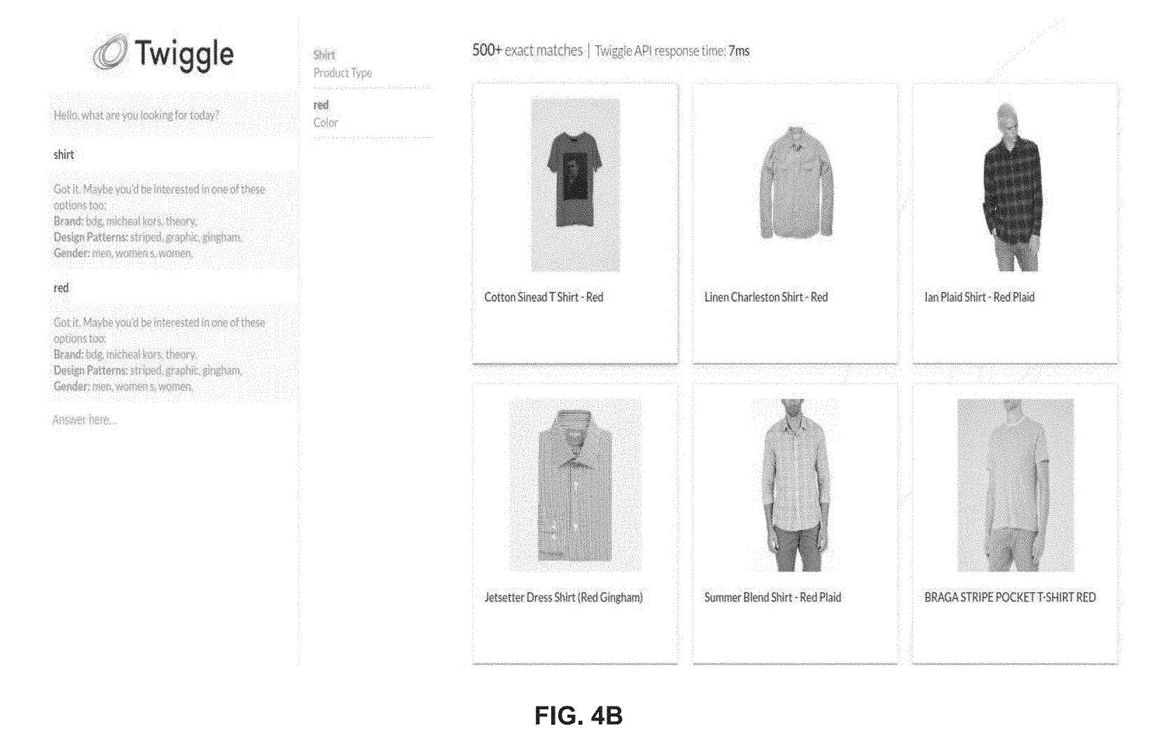

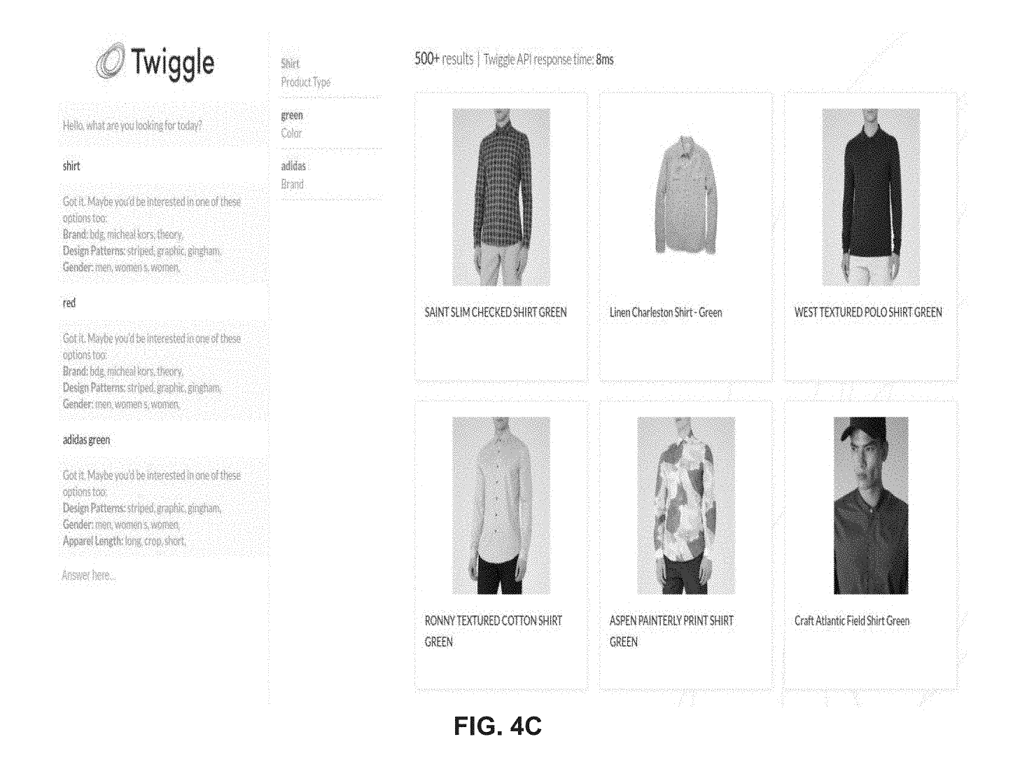

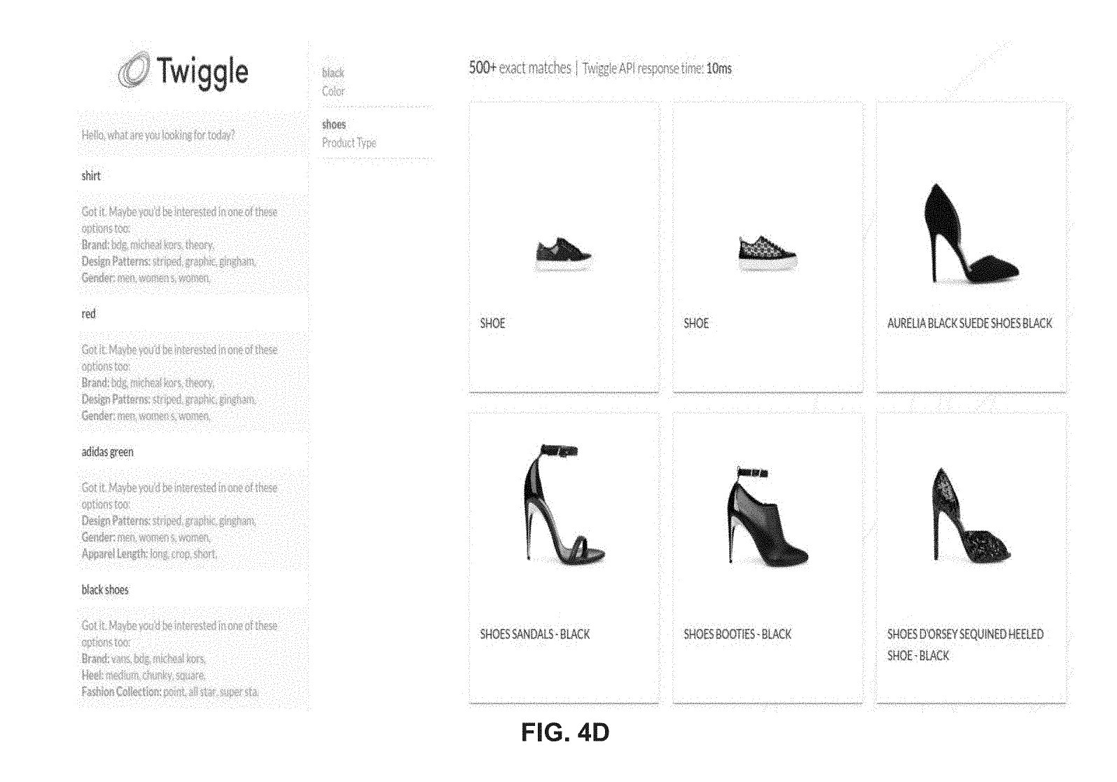

The server system 200 may be executed on one or more servers and/or virtual machines, facilitating the enhancement of a search service 220 which may be iterated or external to the server system 200. The server system 200 further includes a memory 203 storing a code 204 for providing complementary phrase terms are described with reference to FIG. 1 and/or FIGS. 4A-D. The server system 200 includes one or more processors 201 and a network interface 202. Communication between the server system 200 and the search service 220 and/or the client devices 210 and/or a memory, such as an internal memory or a database 205, are performed may be performed either directly and/or via a computer network 206. The system architecture may be defined as described in U.S. patent application Ser. No. 15/416,337 Filed on 26 Jan. 2017 and/or in U.S. patent application Ser. No. 15/275,620 filed on 26 Sep. 2016 which are incorporated herein by reference.

First, as shown at 101, a co-appearance prevalence of each of a plurality of attribute values of each of a plurality of attributes of each of a plurality of product categories in search queries submitted to a search service 220 is maintained, accessed and/or received. For example, the plurality search queries are queries submitted by a plurality of different browsing users to the search service 220 such as a search engine of an e-commerce website or an online catalog. The queries are optionally stored in the database 205. The number of search queries documented in the model may be more than 1,000, 10,000, 100,000, 1,000,000, 100,000,000 and/or any intermediate or larger number. For example, the search queries are gathered search queries after being originated from a user interface such as a graphical user interface (GUI) or an audible user interface (AUI) of an e-commerce website or be taken from dataset of searches, e.g. a subset of searches related to a specific domain (such as home products, apparel etc.) recorded by a general-purpose search service.

The received search queries maybe summarized into a list of unique search query records each consists at least of the phrase terms (e.g. in text) and a number of times that the respective unique search query was used. Optionally, the search queries are processed by canonization, for instance based on the model and/or a universal Semantic Coode (USC). In such a manner, search queries with different phrase terms may be processed as identical search queries when the different phrase terms have semantic similarity above a predefined rank and/or semantic similarity modeled in the model (e.g. the different phrase terms are marked as synonyms). This allows ignoring grammatical structure of search queries. For instance, 1000 queries for “sleeved shirt” and 1000 queries for “shirt with sleeves” may be canonized to be 2000 queries having the product category shirt with the value sleeved in the attribute design.

The mapped co-appearance prevalence is optionally of co-appearance of an attribute value of a certain attribute of a certain product category with each possible attribute value of a different attribute of the certain product category. The co-appearance prevalence is optionally a score value or a rank value, referred to herein as a co-appearance prevalence value, given to a link or an edge between two nodes representing two attribute values of different attributes and is calculated based on the number of the co-appearance s two attribute values of different attributes in search queries submitted to the search service 220. The co-appearance prevalence value may also be given to a link between an attribute value and the certain product category. An appearance prevalence value may be used for calculating co-appearance of three attribute values of three different attributes or any larger number of co-appearance of attribute values of different attributes. This calculation may be done by averaging or otherwise combining co-appearance values of every pair of attribute values among a larger group of attribute values, for example giving a triple attribute co-appearance value, a quorate attribute co-appearance value, and a quintet attribute co-appearance value and/or the like.

Optionally, the co-appearance values are given to edges connecting nodes of a graph, for instance a hierarchical model. As discussed herein, the model may be a Product model mapping products or e-commerce products according to categories or concepts. Each product is represented by a plurality of attributes such as, for example, Brand, Price, Place of Manufacture, and/or any other suitable product attributes. Each attribute may include a possible value space. The model 100 may define possible values per attribute. Some attributes are enriched attributes, attributes that are calculated based on other attributes, based on formulas representing domain expert knowledge and/or based on automated machine learning code about relationships between the attributes. The model may be defined as described in U.S. patent application Ser. No. 15/416,337 Filed on 26 Jan. 2017 and/or in U.S. patent application Ser. No. 15/275,620 filed on 26 Sep. 2016 which are incorporated herein by reference.

As such a model provides rich ontology, the error of proposing the same suggestion under two names is usually avoided. For instance, as “MK™” and “Michael Kors™” are defined as synonym, both “MK™” and “Michael Kors™” are not simultaneously presented as complementary phrase terms but rather represented by the more prevalent appearance of the possible synonyms which are mapped in the model. Additionally or alternatively, a term index is used to associate between different synonyms or terms having similar meanings. It should be noted that as used in this document a term may include one or more words. For example, the index may associate between terms such as MK and Michael Kors and/or between two search phrases that can be mapped to the same concept such as “red v neck shirt” and “shirt with V-neck shaped collar”. The index may include brand dictionaries and databases for synonyms, for instance for brands.

Now, as shown at 102, at the server system 200, an evolving search phrase is received from one or more search requestor(s) at one or more client device(s) 210 distinct from the server system 200. A client device 210 is optionally any client device executing a browser and/or a client application, for example a mobile device, a laptop and/or a desktop. In the first iteration, the evolving search phrase is an initial search phrase inputted by a user and defines a basis for a search and for building a search phrase with high effectiveness score. At following iterations, the evolving search phrase includes phrase terms from the initial search phrase and additional phrase terms as described below. The search may be conducted by a single search requestor at a single client device(s) 210 or from multiple search requestors at a number client devices 210 based on a shared search logic, for instance based on input of a number of participants of a session, such a chat session, with a searching engine agent such as a searching engine chat bot.

The effectiveness score is optionally any index or a measure that ranks a quality of a search. The effectiveness score is optionally determined by the wisdom of the crowd, for instance based on the co-appearance prevalence. The co-appearance prevalence indicates that a relatively high number of distinct people used a combination of attribute values in association with a certain product category and therefore implies that the combination of attribute values may be effective for achieving results that includes products suitable for a searcher desire in the respective product category, also referred to herein as concept. In this document a product category may be a service category.

Now, as shown at 103, attribute values of the evolving search phrase are analyzed to identify a group of attributes of one of the product categories which are documented in the model and optionally one of the product categories.

Optionally, a product category for the search is either extracted from a text analysis of the evolving search phrase and/or deduced form the context of search and/or from the GUI used for the search. Alternatively, a product category for the search is automatically deduced from attribute values when the product category is not provided. For example, the product category “shirt” is deduced from the evolving search phrase “red” and “Lacoste™”, for instance by analyzing the historical data and determining the co-appearance of the attribute values “red” and “Lacoste™” is highest in the product category “shirt”. In another example, the product category “shoes” is deduced from the evolving search phrase “white” and “Adidas™”, for instance by analyzing the historical data and determining the co-appearance of the attribute values “white” and “Adidas™” is highest in the product category “shoes”. Indirect attributes may also me deduced from the text analysis of the evolving search phrase, for instance using contextual search algorithms.

In use, the evolving search phrase may be divided to a phrase terms defining a product category and attribute values and each one of the attribute values is associated with an attribute with respect to the product category. For example, the evolving search phrase: “red laptop with i5” is divided to a product category: “laptops” (Concept: Laptop) and to the attribute values: “color: red”, “CPU”->“Brand”: “Intel™”, “CPU”->“processor_family”: “i5” (Laptop itself may have a different brands like “Asus™” or “Dell™” and “Intel™” applies to the brand of the CPU. In another example, the evolving search phrase: “black pants for men” is divided to a product category: “pants” and to the attribute values: “color: black” and “gender based style: men”. Other attribute values which may be deduced, for instance using contextual search algorithms, are product category: “pants”, color: “black”, gender based design: “male” and age group: “adult”. The analysis of the evolving search phrase is optionally performed using a content analysis such as natural language processing (NLP), for example using an NLP engine as described in U.S. patent application Ser. No. 15/416,337 Filed on 26 Jan. 2017 and/or in U.S. patent application Ser. No. 15/275,620 filed on 26 Sep. 2016 which are incorporated herein by reference. The content analysis optionally includes parsing using the model which is optionally a hierarchic model as described above.

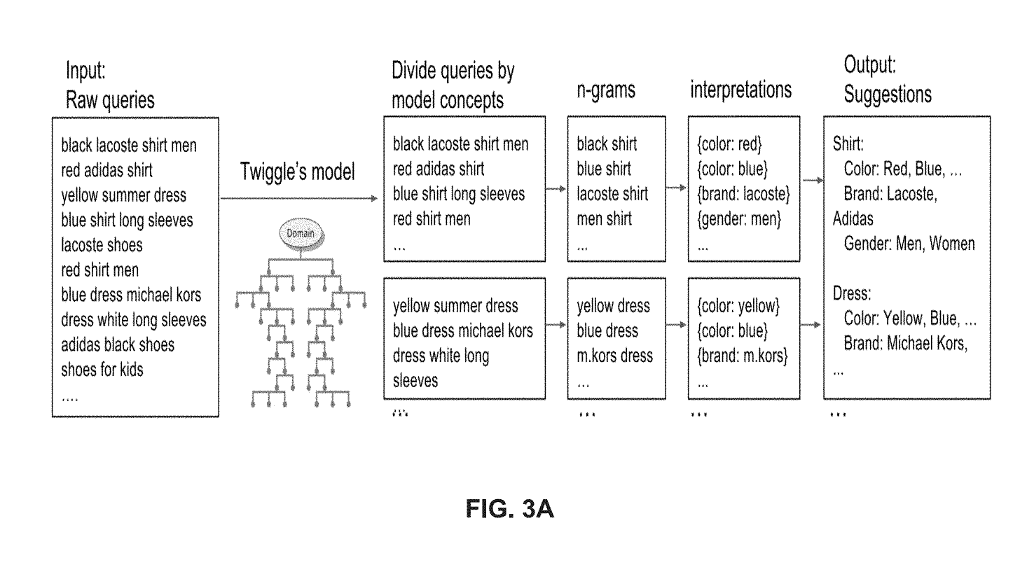

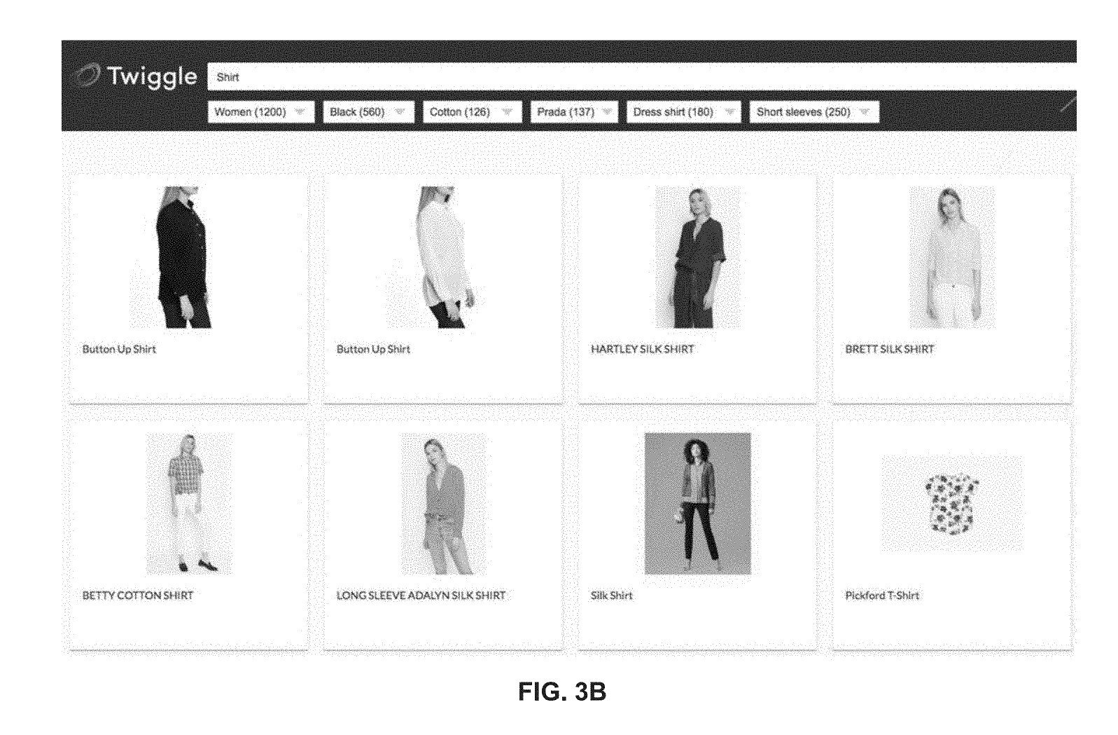

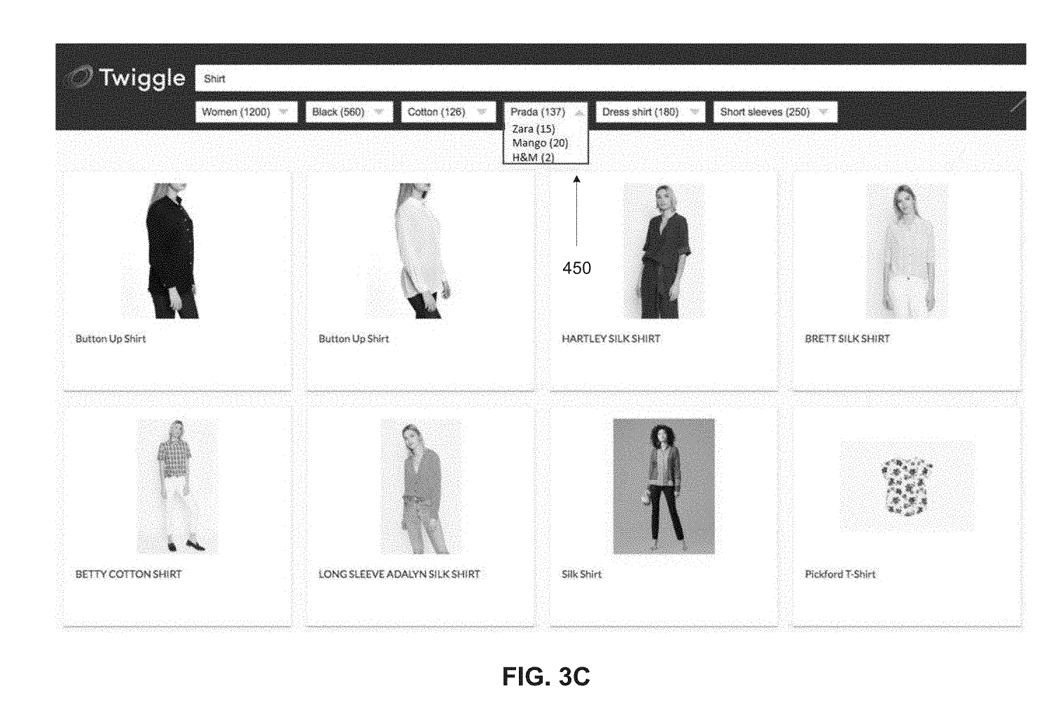

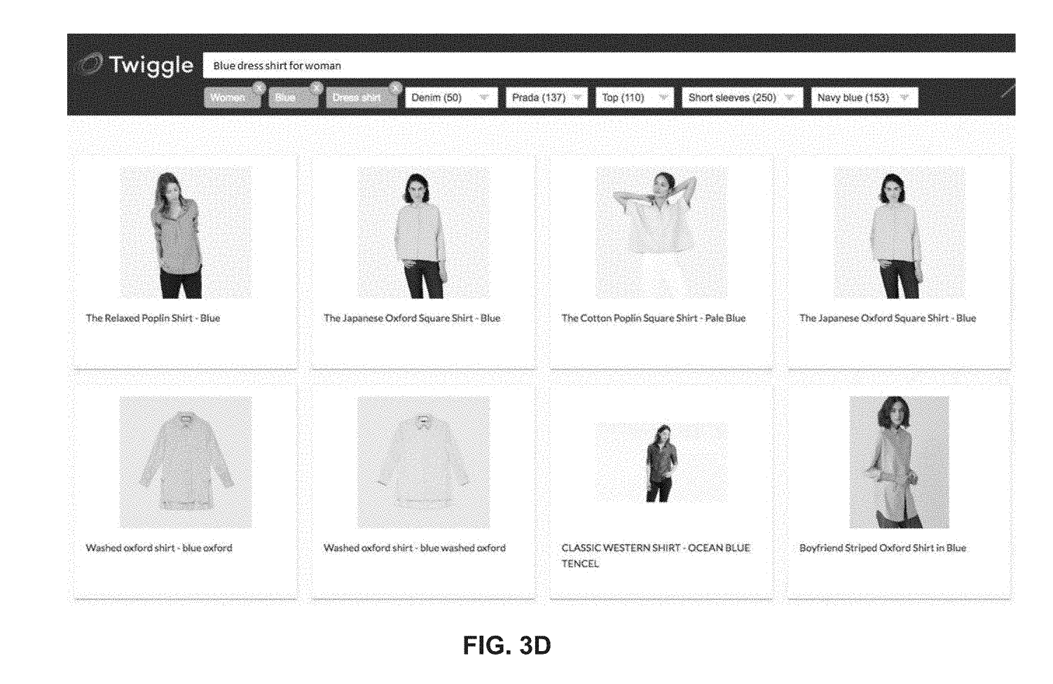

As show at 104, the server system provides instructions to present a response to the evolving search phrase. This is optionally done by submitting the attribute values of the evolving search phrase as a search query to the search service 220. Examiner responses are presented in FIGS. 3B-3D and in FIGS. 4A-4D.

Now, as shown at 105, one or more complementary phrase terms are identified. The complementary phrase terms are optionally a group of attribute values which are not found as phrase terms in the current evolving search phrase and having the highest co-appearance prevalence among attribute values which are linked to the attribute values and/or the product category defined in the current evolving search phrase.

For example, when the evolving search phrase is for the concept “shirt”, most popular search queries are identified based on the co-appearance prevalence, for example: Red shirt, Adidas™ shirt, Black shirt, Lacoste™ shirt, Men's shirt, and Michael Kors™ shirt. The complementary phrase terms which are calculated based on the most popular search queries are: the values red and black for the attribute color, the values Adidas™, Lacoste™, and the Michael Kors™ for the attribute brand, and the value Men for the attribute gender. FIG. 3A is an exemplary flow depicting how raw queries are translated into output suggestion of complementary phrase terms sorted according to attribute types.

The complementary phrase terms are identified based on the assumption that adding any or some of them to the evolving search phrase increases the evolving search phrase effectiveness score of the evolving search phrase when the evolving search phrase is submitted to the search service 220.

As shown at 106, instructions to present the complementary phrase term(s) are sent to the client device from the server system. The presentation is optionally in association with the evolving search phrase so as to allow a user to select one or more of them for enhancing the currently pending evolving search phrase, creating an enhanced evolving search phrase. Such complementary phrase term(s) are used for refinement, and may be referred to as “Facets”. For example, the each of the complementary phrase terms is represented by an interactive control button so as to allow a user to submit an additional evolving search phrase that combines the respective complementary phrase term with the attribute values which are currently defined in the evolving search phrase.

A complementary phrase term may be selected by a single click or touch or gesture indicative of a respective selectable GUI element such as a word (e.g. see FIGS. 4A-4D) or a dynamically added facet button (e.g. see FIGS. 3B-3D). Optionally, the facets are presented as buttons in proximity to the search field, for instance as depicted in FIG. 3B. Multiple facets of the same attribute type are clustered to be selected in common GUI element such as a combo box as shown by reference numeral 450 at FIG. 3C. The facets of the same attribute type are optionally ordered according to the co-appearance prevalence score. As shown at FIG. 3D, the attribute values may be presented as selectable buttons, allowing a user to remove them from the evolving search phrase.

As shown at 107, a new evolving search phrase is calculated and submitted to the search service in response to the selection of one of the complementary phrase term(s). The outcome of submitting an evolving search phrase combining phrase terms of the previous evolving search phrase (e.g. initial or non initial search phrase) and the selected complementary phrase term(s) is presented to the user, in association with the evolving search phrase, optionally together with new complementary phrase terms which are calculated based on an analysis of the evolving search phrase as described in 105. For example FIG. 4B depicts an outcome of executing the process when the initial evolving search phrase is “shirt” (e.g. see FIG. 4A) and the following evolving search phrase is “red”. In this case, for the concept (i.e. product category): “shirt” and attribute value “red”, the possible additions with the highest co-appearance prevalence are values of the attribute Brand (e.g. BDG™, Michael Kors™, Theory™) and values of the attribute Design Patterns (e.g. striped, graphic, and gingham). In another example, upon user selection in an AUI or a GUI such as the GUI depicted in FIG. 3C, the facets content is added to the query search bar and facets are recalculated; see for example FIG. 3D.

As shown at 108, this allows repeating 104-107 iteratively to allow a user to improve the effectiveness of its evolving search phrase with simple selections, saving the user time and effort to identify search queries with higher effectiveness then the evolving search phrase she or he initially submitted.

The initial evolving search phrase and the one or more evolving search phrases which include phrase terms defined in the initial evolving search phrase as described with reference to 102-108 are cumulatively referred to herein as inputs of a conversational search thread. In the above described process, the server system 200 processes the inputs of the conversational search thread. For example, when a user inputs as an initial query: “shirt”, the complementary phrase terms which are suggested are the most frequent phrase terms co appeared with the attribute value “shirt”, for example attribute values of the attribute type color (e.g. red, green, blue), attribute values of the attribute type brand (e.g. Lacoste™, Michael Kors™, and Adidas™) attribute values of the attribute type gender and/or the like. For the query “Pants” for example, the suggestions may be attribute values of attributes such as material, gender, and brand.

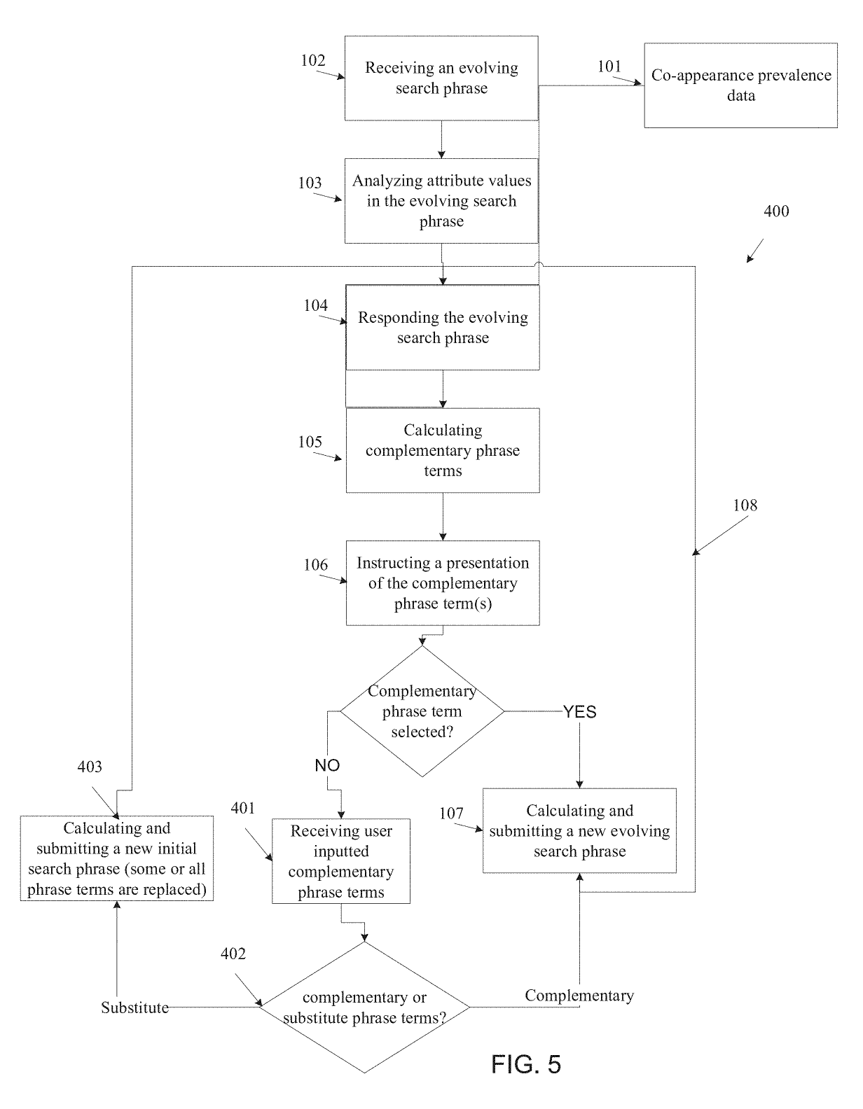

Reference is now made to FIG. 5, which is a flowchart 400 for managing a conversational search thread, according to some embodiments of the present application. 101-108 are as described above with reference to FIGS. 1 (101 and 107-108 are optional); however, the flowchart 400 further comprises 401-402, describing replacement of a phrase term in one evolving search phrase with another in the following evolving search phrase. The process allows automatically classifying user input with reference to a pending search query, either as including substitutional phrase term(s) or complementary phrase term(s). In such a manner some or all of the phrase terms of a pending search query may be replaced and/or enhanced during a conversational search thread in an automatic manner, without requiring from the user to start a new conversational search thread. In such a manner, a digital assistant may be used for providing search results in a flow of a single chat, without requiring from the user to initiate a new logical chat or to open a new search tread.

In 401, user inputted complementary phrase terms are received as an input from the user, for example when the user uses a search input field and/or any phrase term input interface as a GUI or an AUI. The input is received when the current state of the search in presented to the user. The current state may be the last submitted evolving search phrase, for example as described with reference to 106.

In 402, user inputted complementary phrase terms are analyzed to determine whether the user inputted complementary phrase terms include attribute value(s) which are substitute attribute values or complementary attribute values to the existing search phrase which is referred to herein also as a current state.

Substitute attribute values are attribute values which are defined as substitutable with attribute values in the current state (e.g. attribute values of the same attribute, for instance different brands, colors or styles). For example, when a new product category is identified among the phrase terms added as an input by the user, it is determined that the identified attribute value(s) are new attribute values of the new product category and the previous attribute values of the previous product category are removed. In such a manner, the context's product type changes when the user specifies a query that contains a new concept for example after the query “shirt” the user writes “red shoes”. In this case, the entire context is overwritten, and any previously inputted attribute values are discarded.

Complementary attribute values are values that increase the effectiveness of the evolving search phrase in the current state when forming a new search query by adding the user inputted attribute value(s) to the attribute values of the previous evolving search phrase of the current state. In use, every new evolving search phrase may be compared with a current search state that includes the last search product category and attribute values of the product at the last search product category. When the new query has the same product type as the one defined in the current state or has no product type then the context is preserved and the user inputted complementary phrase terms are used as complementary phrase terms.

When the new attribute value(s) do not exist in the current state, the attribute value(s) are added to phrase terms from the previous evolving search phrase to form a new evolving search phrase using the user inputted complementary phrase terms. When a new attribute value and a previously provided attribute value are of the attribute of the same category, the previously provided attribute value is replaced with the new attribute value and a new evolving search phrase is formed. For example the current state is “red Adidas™ shirt” and the new query is “Lacoste™”, the new evolving search phrase is “red Lacoste™ shirt”.

As shown at 403, substitute attribute values may be used for creating a new search phrase, with or without attribute values from previous inputs and/or evolving search phrases. For example, a search query may be replaced completely when the concept is different and/or adjusted by replacing some of the phrase terms when substitutional phrase term(s) are detected.

Reference is now made to FIGS. 4A-4D which are screenshots of responses to exemplary evolving search phrases, according to some embodiments of the present invention. In FIG. 4A, the evolving search phrase is inputted and a number of facets are calculated and a presented as described above. The evolving search phrase is “shirt”. In FIG. 4B, the evolving search phrase is attribute value red of attribute color of the category product shirt. This evolving search phrase is formed in response to input of the phrase term “red” by the user after and optionally while the results of the evolving search phrase “shirt” are presented to him. When an input of the phrase term does not indicate a product category, a previously provided product category from the same conversational search thread is reused. In FIG. 4C, the evolving search phrase includes the attribute value Adidas™ and the attribute value “green” instead of the previously used “red”. In the user input a new product category is not provided by the user; however, a color and brand specified. As a color was previously provided, the previously provided color is replaced. As a brand was not previously provided, the added brand is used for a new evolving search phrase. As shown at 4D, once the user explicitly changes the concept, e.g. by searching for “black shoes”, the context and the current state are completely overwritten.

Reference is now made to pseudocode describing the evolving search phrases depicted in FIGS. 4A-4D.

We start with the query “shirt”, which returns the following interpretation:

```
{
  ″$concept″: {
  ″@eq″: ″Shirt″
  }
}
```

This interpretation and the main concept (Shirt) is added to a current state.

The next query is “red” which returns interpretation with no specific main concept but just a “FashionProduct”.

```
{
  ″@combine″: [
      {
        ″$concept″: {
        ″@eq″: ″FashionProduct″
        }
      },
    {
    ″$color_s″: {
        ″@eq″: ″Red″
        }
    }
    ]
}
```

So the query re-run on the query “red” with the current main concept from the state, the new query is “red shirt”. The new interpretation is:

```
{
  ″@combine″: [
      {
        ″$concept″: {
            ″@eq″: ″Shirt″
          }
      },
      {
        ″$color_s″: {
        ″@eq″: ″Red″
        }
      }
    ]
}
```

The next query is “green adidas”, the interpretation again has no main concept, but just “FashionProduct”:

```
{
  ″@combine″: [
      {
        ″$concept″: {
            ″@eq″:
    ″FashionProduct″
          }
      },
      {
        ″$color_s″: {
        ″@eq″: ″Green″
      }
      },
      {
        ″$brand_s″: {
        ″@eq″: ″adidas″
      }
      }
    ]
}
```

So it is combined with the current state main concept “Shirt”. In the current interpretation, the attribute “color” is already specified to be “red”, so the system substitutes it with “green”. The new interpretation is:

```
{
  ″@combine″: [
      {
        ″$concept″: {
        ″@eq″: ″Shirt″
        }
      },
      {
        ″$brand_s″: {
        ″@eq″: ″adidas″
      }
      },
      {
        ″$color_s″: {
        ″@eq″: ″Green″
        }
      }
    ]
  }
```

Finally, the last query is “black shoes”. The interpretation is:

```
{
″@combine″: [
    {
    ″$concept″: {
        ″@eq″: ″Shoe″
        }
    },
    {
    ″$color_s″: {
          ″@eq″: ″Black″
      }
    }
  ]
}
```

Since the query explicitly specified the concept, the system overrides the current state main concept “Shirt” with the new main concept “Shoes” and all other attributes (color and brand) being removed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a processor, a model, a user interface, a server, and a client is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computer-implemented method performed at a server system for enhancing search queries received from client devices, comprising:
maintaining a dataset mapping a co-appearance prevalence of at least two attribute values, each of a different one of a plurality of attributes of each of a plurality of product categories in a plurality search queries submitted to a search engine, said co-appearance prevalence indicates a prevalence of users using a combination of at least one of said two attribute values of one of said plurality of attributes of a certain product category together with an attribute value of another one of said plurality of attributes of said certain product category;
during a single search thread which comprises a plurality of query iterations, receiving at the server system a plurality of evolving search phrases from a search requestor at a client device that is distinct from the server system, each of said plurality of evolving search phrases is submitted in another one of said plurality of query iterations and is different from an evolving search phrase of a preceding query iteration by at least one phrase term;
at the server system, responding to each of the plurality of evolving search phrases by:
performing a content analysis of the respective evolving search phrase to identify a group of attribute values of values from the plurality of attributes of one of the plurality of product categories;
identifying a plurality of complementary phrase terms to the respective evolving search phrase according to respective the co-appearance prevalence related to members of the group of attribute values; and
instructing a presentation of a response to the respective evolving search phrase with the plurality of complementary phrase terms in association with a plurality of interactive elements;
wherein a selection of one of the plurality of interactive elements triggers a submission of a following evolving search phrase, used in a following query iteration, from the search requestor at the client device, the following evolving search phrase combines the selected complementary phrase term with at least some members from the group.

2. The computer-implemented method of claim 1, wherein the responding comprises submitting the respective evolving search phrase to a search engine and acquiring the response from the search engine.

3. The computer-implemented method of claim 1, wherein the at least two attribute values and the plurality of attributes of each of the plurality of product categories are mapped in a hierarchic object model mapping hierarchic relations between the plurality of attributes; wherein the identifying is performed using the model.

4. The computer-implemented method of claim 1, wherein the content analysis comprises a natural language analysis of the respective evolving search phrase.

5. The computer-implemented method of claim 1, wherein the group of attribute values are parsed using the hierarchic model.

6. The computer-implemented method of claim 1, wherein the evolving search phrase is an input text provided by a user during a conversational search.

7. The computer-implemented method of claim 1, further comprising at the server system, responding to at least one additional evolving search phrase by:
identifying a new attribute value in the at least one additional evolving search phrase;
when the new attribute value is of an existing attribute value of a similar attribute in the following evolving search phrase, replacing the existing attribute value with the new attribute value and submitting an adapted version of the following evolving search phrase as an additional evolving search phrase from the search requestor at the client device; and
when the new attribute value is of an attribute having no value in the following evolving search phrase, adding the new attribute value to the following evolving search phrase and submitting the enhanced version of the following evolving search phrase as an additional evolving search phrase from the search requestor at the client device.

8. The computer-implemented method of claim 1, further comprising at the server system, responding to at least one additional evolving search phrase by:
identifying a product category in the at least one additional evolving search phrase;
when the product category is different from a product category identified in the following evolving search phrase, starting a new search thread.

9. A server system for enhancing search queries received from client devices, comprising:
a memory adapted to store a dataset mapping a co-appearance prevalence of at least two attribute values, each of a different one of a plurality of attributes of each of a plurality of product categories in a plurality search queries submitted to a search engine, said co-appearance prevalence indicates a prevalence of users using a combination of at least one of said two attribute values of one of said plurality of attributes of a certain product category together with an attribute value of another one of said plurality of attributes of said certain product category;
at least one processor adapted to:
receive, during a single search thread which comprises a plurality of query iterations, a plurality of evolving search phrases from a search requestor at a client device that is distinct from the server system, each of said plurality of evolving search phrases is submitted in another one of said plurality of query iterations and is different from an evolving search phrase of a preceding query iteration by at least one phrase term;
respond to each of the plurality of evolving search phrases by:
performing a content analysis of the respective evolving search phrase to identify a group of attribute values of values from the plurality of attributes of one of the plurality of product categories;
identifying a plurality of complementary phrase terms to the respective evolving search phrase according to respective the co-appearance prevalence related to members of the group of attribute values; and
instruct a presentation of a response to the respective evolving search phrase with the plurality of complementary phrase terms in association with a plurality of interactive elements;
wherein a selection of one of the plurality of interactive elements triggers a submission of a following evolving search phrase, used in a following query iteration, from the search requestor at the client device, the following evolving search phrase combines the selected complementary phrase term with at least some members from the group.

10. A computer-implemented method performed at a server system for processing a conversational search thread, comprising:
during a single search thread which comprises a plurality of query iterations, sequentially adding to each of said plurality of query iteration, at the server system, a plurality of phrase terms from a search requestor at a client system distinct from the server system, in response to each sequential addition of the plurality of phrase terms updating a presentation of a response to a current state of the search thread;
in each of the sequential addition:
when a first attribute value of a specific attribute identified in one of the plurality of phrase terms is different from a second attribute value of the specific attribute in a preceding phrase term, replacing the first attribute value with the second attribute value in the current state of the search thread;
when a third attribute value of an attribute not currently found in the current state of the iterative search is identified in one of the plurality of phrase terms adding the third attribute value to the current state of the search thread; and
when a product category in a third phrase term of the plurality of phrase terms is different from a product category identified in a preceding phrase term, deleting all attribute values in the current state of the search thread.

11. The computer-implemented method of claim 10, wherein in each of said plurality of query iterations of the sequential addition the response is acquired from a search engine by submitting one of the second attribute value, the third attribute value, and the third phrase term to the search engine.

12. The computer-implemented method of claim 10, wherein in each of said plurality of query iterations of the sequential addition a natural language analysis is used to deduce the plurality of phrase terms.

13. The computer-implemented method of claim 10, wherein the plurality of phrase terms are provided by a user during a conversational search.
